(19) United States
(12) Patent Application Publication
(10) Pub. No.: US 2004/0175656 A1
(43) Pub. Date: Sep. 9, 2004

(54) Photo-patternable nanomaterials

(76) Inventors: Eric Baer, Cleveland Heights, OH (US); P. Anne Hiltner, Cleveland, OH (US); Christoph Weder, Shaker Heights, OH (US)

Correspondence Address: STAMATIOS MYLONAKIS, 7009 CASHELL MANOR COURT, DERWOOD, MD, 20855-1201, US

(21) Appl. No.: 10/788,363

(22) Filed: Mar. 1, 2004

Related U.S. Application Data
(60) Provisional application No. 60/452,015, filed on Mar. 6, 2003.

(51) Int. Cl. G03C 1/73

(52) U.S. Cl. 430/290

(57) ABSTRACT

Light-reflecting multilayer polymer films that irreversibly change their optical characteristics upon exposure to suitable, high-intensity irradiation.

This Application claims priority on Provisional Application Serial No. 60/452,015 filed Mar. 6, 2003, which is incorporated herein by reference in its entirety.

### BACKGROUND OF THE INVENTION

1. Field of the Invention

The present invention is directed to light-reflecting multilayer polymer films that irreversibly change their optical characteristics upon exposure to suitable, high-intensity irradiation.

2. Discussion of the Related Art

The treatment of optic polymers by UV radiation is a rapidly developing area of modern research in applied materials science and physics. The energy-rich UV radiation leads to electronic excitation of UV-absorbing chromophores, and thereby can initiate photochemical reactions. These reactions modify the polymeric structure and allow the creation of specific functional properties in the exposed area.

The present invention is directed to novel materials systems, in which the refractive index can be controlled by this methodology. Of particular interest are multilayer polymer films containing hundreds or even thousands of thin layers of two or more different thermoplastic polymers in strictly alternating fashion. Such materials are of interest for a variety of applications that range from optical waveguides to optical data storage elements.

Multilayer polymer films containing hundreds or even thousands of thin layers of two or more different thermoplastic polymers in strictly alternating fashion can be conveniently and economically produced by layer-multiplying coextrusion. If two optically transparent polymers with different refractive indices are used, the resulting films exhibit pronounced optical interference effects. The latter cause the reflection of incident light of certain wavelengths, while allowing the transmission of light of other wavelengths. The reflection and transmission characteristics of these films primarily depend on the thickness of the layers, which are typically in the range of 10 to 300 nanometers, as well as the refractive indices of the two polymers employed. By carefully tailoring these parameters, films can be designed to selectively reflect in the regions of the near infrared, visible or ultraviolet wavelength regime of the electromagnetic spectrum, respectively.

A variety of uses of such polymer interference films exists. Multilayer interference films that reflect visible light display vivid iridescent characteristics and can be used in decorative applications, for example as iridescent wrapping foil. Technologically more advanced is the use of multilayer polymer films as photonic materials. Other examples include the application of coextruded multiplayer films as low-cost substitutes for conventional dielectric mirrors and highly efficient reflective polarizers, which have recently been introduced into the market.

As outlined above, the optical characteristics of a multilayer interference film can be tailored by its architecture and by the refractive indices of the two polymers used. Once the film is produced, however, its optical characteristics are set and no possibility for subsequent modification exists. Unfortunately, these elements also do not allow for patterning or structuration in a spatially resolved manner.

### SUMMARY OF THE INVENTION

Thus, it is an object of the present invention to make novel optical interference films available, the optical characteristics of which can be manipulated in controlled and spatially resolved fashion after the films have been produced. In accordance with the present invention there are created optical elements that rely on a multilayer architecture, that comprise a photoreactive polymer, the refractive index of which can be altered by irradiation with a suitable light source.

Thus multilayer polymer films are formed that are originally transparent but irreversibly change their optical transmission characteristics upon exposure to suitable, high-intensity irradiation. Thus, the generation of any desired pattern and even gradients in optical interference films can be achieved by standard lithographic methods. Such materials are of interest for a variety of applications that range from optical data storage elements advanced optical interference filters. A most interesting initial business opportunity is the exploitation of these new concepts in the manufacture of novel “smart” anti-counterfeit features (“security features”) and identification marks. It should be pointed out that the photo-reactive material to be used is novel per se. Our initial experiments suggest that this material may be an extremely attractive materials platform that may find broader application than only in the presently proposed nanomaterials, but, e.g., may be used as basis for optical waveguides. To our best knowledge, optical interference films that can be produced at relatively low-cost which can be patterned by a simple lithographic method have hitherto not been developed.

A variety of potential applications of the new optical elements can be envisioned, which widely vary in their nature and degree of sophistication. Examples on the low-tech end include individualizable decorative materials. Here, a dramatic advantage of the new materials is their ability to be patterned by means of inexpensive UV light sources, rather than by currently employed, expensive lasers. More advanced applications embrace photonic bandgap materials, devices for optical data storage, and optical interference filters with spatially graded transmission characteristics.

In accordance with the present invention, security features are unique in that they (i) meet the need of ease of individualization/personalization (e.g., with a serial number, the picture of a credit card holder, etc.), (ii) display a complex, yet readily detectable optical effect (an angle-dependent interference pattern), (iii) are difficult to counterfeit, (iv) can be used in different forms of application (which range from security threads to hologram-type objects), and (v) are inexpensive to produce.

### BRIEF DESCRIPTION OF THE DRAWING

FIG. 1: Schematic representation of the proposed materials with adaptable refractive index. The pristine material (A) has a refractive index n₁. Upon UV irradiation (B) the chemical structure is irreversibly altered (C), concomitant with a permanent change of the refractive index (n₂).

FIG. 2: Schematic representation of the interference films based on the new nanomaterials that allow photo-patterning. (A) The pristine films are transparent, because the refractive indices n₁ and n₂ of the two polymers are matched. (B) Exposure to high-intensity UV light leads to a change of the refractive index of the photoreactive polymer (n₂→n_{2′}). (C) The exposed areas exhibit a dichroic behavior, while the unexposed areas remain transparent.

FIG. 3: Schematic representation of the cutting, stacking and spreading processes that take place in a layer multiplier in the two-component microlayer coextrusion process.

FIG. 4: Dimerization of trans-cinnamic acid.

FIG. 5: Absorption spectra of blend films based on PMMA and a varying content (% w/w) of cinnamic acid.

FIG. 6: Absorption spectra of a blend film based on PMMA and a 10% w/w of cinnamic acid after different exposure times to UV light (254 nm, 350 μW/cm²).

FIG. 7: Chemical structures of the photoreactive guest molecules employed: trans-cinnamic acid (CA) and trans-methyl cinnamate (MC).

FIG. 8: Absorption spectra of blend films based on PMMA and a varying content (% w/w) of cinnamic acid.

FIG. 9: Absorption spectra of blend films based on PMMA and a varying content (% w/w) of methyl cinnamate.

FIG. 10: Differential Scanning Calorimetry (DSC) trace of PMMA/CA blends of different composition.

FIG. 11: Differential Scanning Calorimetry (DSC) trace of PMMA/MC blends of different composition.

FIG. 12: Correlation between the glass transition temperature (T_{g}) of PMMA/CA blends (determined by DSC) and the blend composition (weight fraction of MC).

FIG. 13: Correlation between the glass transition temperature (T_{g}) of PMMA/MC blends (determined by DSC) and the blend composition (weight fraction of MC).

FIG. 14: Dynamic Mechanical Thermo Analysis (DMTA) traces of PMMA/MC blends of different composition.

FIG. 15: Correlation between the glass transition temperature (T_{g}) of PMMA/MC blends and the blend composition (weight fraction of MC). The comparison shows T_{g} data determined by Differential Scanning Calorimetry (DSC) and Dynamic Mechanical Thermo Analysis (DMTA).

FIG. 16: Absorption spectra of a blend film based on PMMA and 10% w/w of cinnamic acid after different exposure times to UV light (UV lamp 254 nm, 350 μW/cm²).

FIG. 17: Absorption spectra of a blend film based on PMMA and 10% w/w of methyl cinnamate after different exposure times to UV light (UV lamp 254 nm, 350 μW/cm²).

FIG. 18: Absorption spectra of a blend film based on PMMA and 10% w/w of methyl cinnamate after different exposure times to UV light (Xe-lamp with monochromator, 280 nm, ca. 1.6 mW/cm²).

FIG. 19: Effect of the radiation intensity on the extent of photoreaction (expressed by the relative intensity of the absorption band) of blend films based on PMMA and 10% w/w of methyl cinnamate as a function of exposure time.

FIG. 20: Infrared absorption spectra of blend films based on PMMA and a varying content (% w/w) of cinnamic acid. The band at 1637 cm⁻¹ is assigned to the ν(C=C) of the monomeric species and allows monitoring the concentration of the latter.

FIG. 21: Infrared absorption spectra of blend films based on PMMA and a varying content (% w/w) of methyl cinnamate. The band at 1637 cm⁻¹ is assigned to the ν(C=C) of the monomeric species and allows monitoring the concentration of the latter.

FIG. 22: Infrared absorption spectra of blend films based on PMMA and 10% w/w cinnamic acid before and after exposure to UV light, and a PMMA reference film.

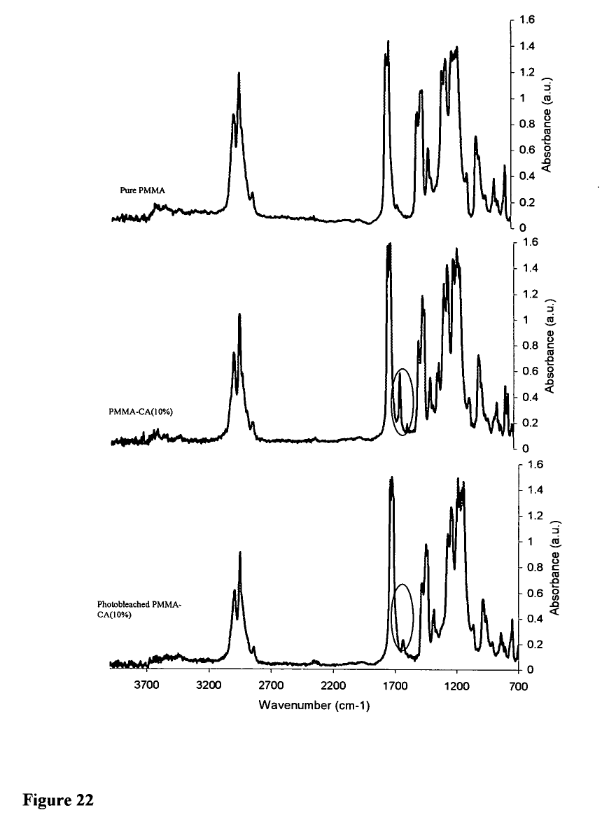

FIG. 23: Differential Scanning Calorimetry (DSC) traces of PC and a PC-CA blend (10% w/w).

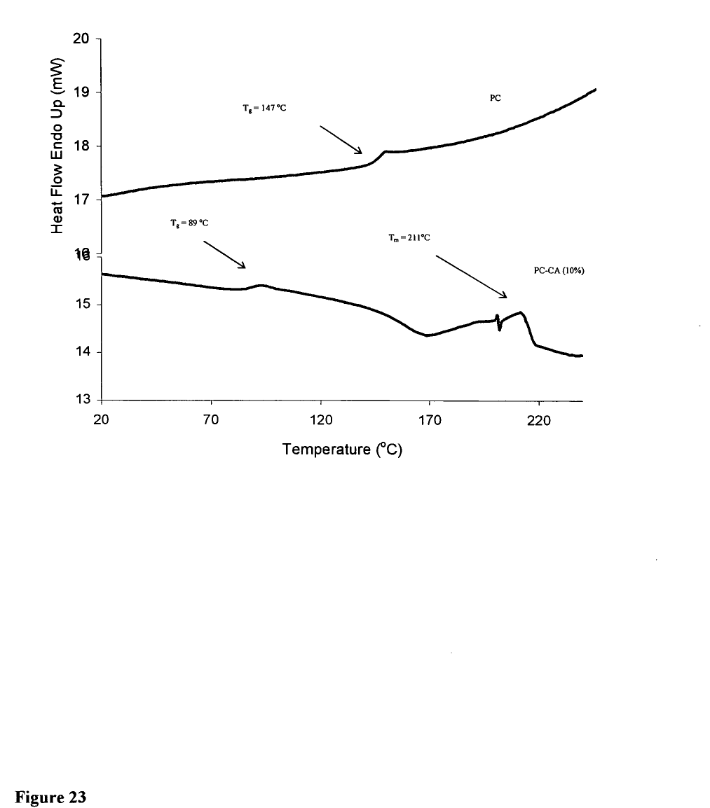

FIG. 24: Absorption spectra of a blend film based on PC and 10% w/w of cinnamic acid after different exposure times to UV light (UV lamp 254 nm, 350 μW/cm²).

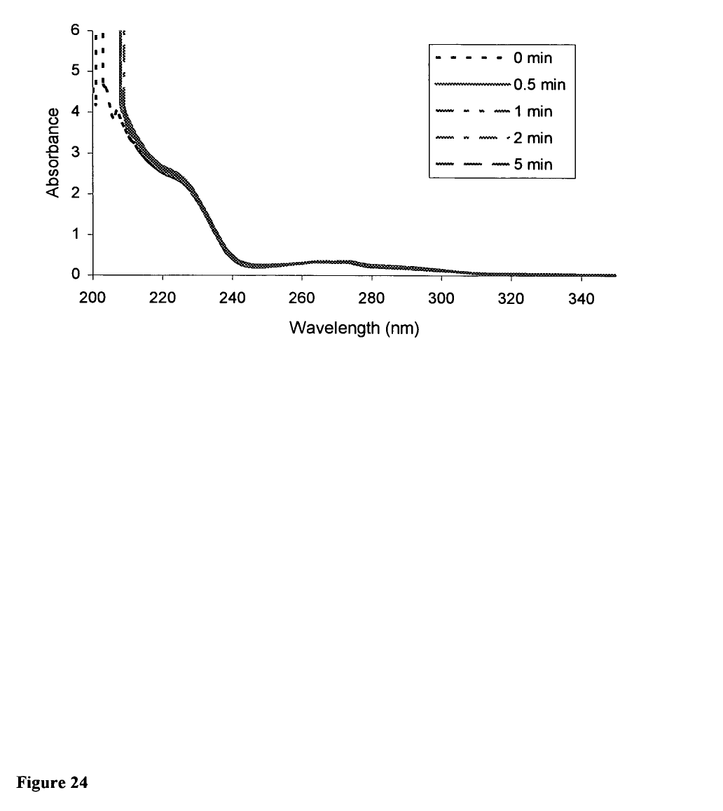

FIG. 25: Dependence of the refractive index of PMMA-CA blends on the composition of the blend. Samples were produced by compression molding blends of different compositions.

FIG. 26: Dependence of the refractive index of PMMA-MC blends on the composition of the blend. Samples were produced by compression molding blends of different compositions.

FIG. 27: Method for measurement of refractive index of a film. A compression-molded film is attached to a grid with 0.25″×0.25″ squares and RI measured at specific points along the diameters and the circumference. 5 measurements each in TE & TM mode per point at 633 nm.

FIG. 28: Refractive indices of five different compression-molded films made from the same batch of PMMA-CA blend, which comprises 11.1% w/w of CA.

FIG. 29: Refractive indices of five different compression-molded films made from the same batch of PMMA-MC blend, which comprises 12.3% w/w of CA.

FIG. 30: Viscosity-temperature curves of four different grades of PMMA.

FIG. 31: Viscosity-temperature curves of PMMA V826 and PMMA-CA blend (12% w/w CA) used for microlayering.

FIG. 32: Optical micrograph of a PMMA/CA/PMMA multilayer film of 1024 alternating layers of a thickness of 100 μm. The film was ‘developed’ by exposure to light of a 100 W Hg lamp through a ‘chessboard’-type mask for 15 min.

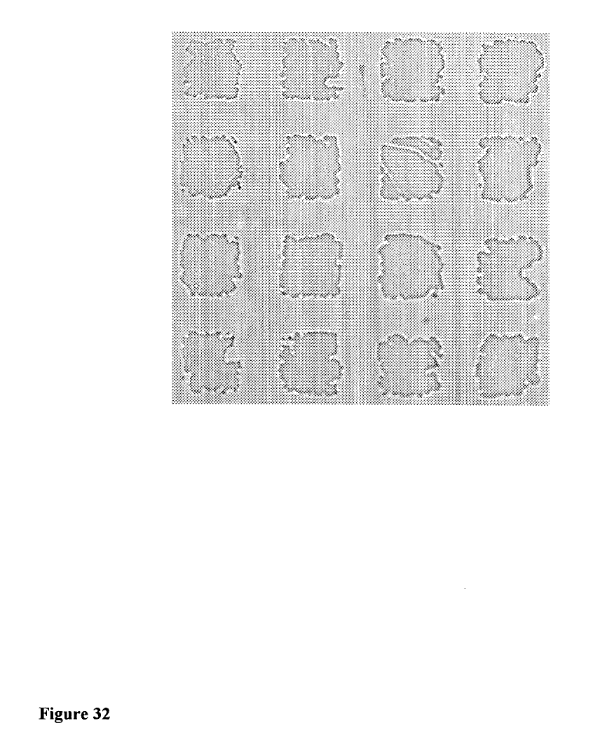

FIG. 33: Schematic representation of the photoactivation of BzPO (left) to the highly fluorescent HPBO (right).

FIG. 34: Picture of a PMMA/BzPO/PC multilayer film of 1024 alternating layers of a thickness of 75 nm. The film was ‘developed’ by exposure to UV light of a wavelength of 254 nm through a ‘chessboard’-type mask. The picture was taken on a Leica microscope under excitation with UV light of a wavelength of 365 nm.

### DESCRIPTION OF THE PREFERRED EMBODIMENTS

Methods

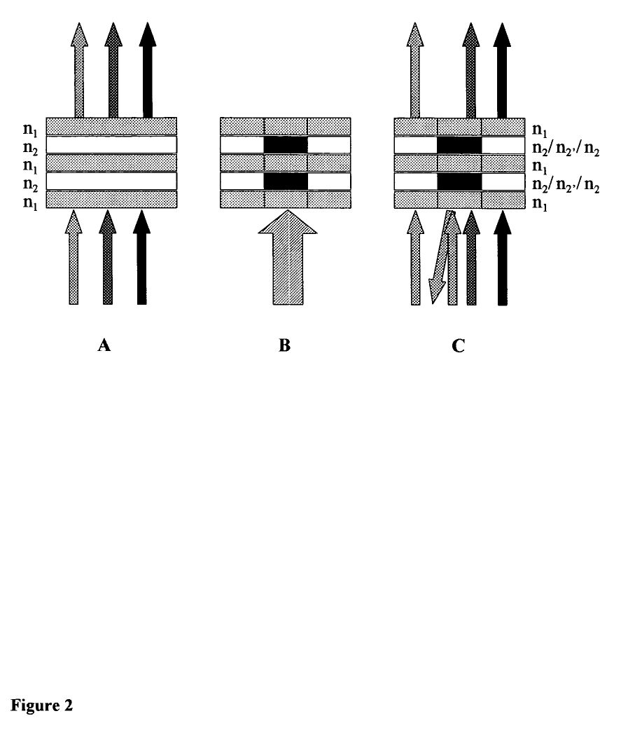

It is, therefore, an object of the present invention to develop optical interference films based on photo-patternable nanomaterials and the design and application of polymeric materials with novel and unusual optical characteristics, which also include the optical patterning of the latter. Multilayer films, in accordance with the present invention, contain several hundreds thin layers of two different transparent thermoplastic polymers in strictly alternating fashion (FIG. 2A). One polymer is chosen to be optically inert, while the second polymer is tailored to undergo a photochemical reaction when exposed to intense ultraviolet (UV) light, and as a result changes its refractive index (FIG. 2B).

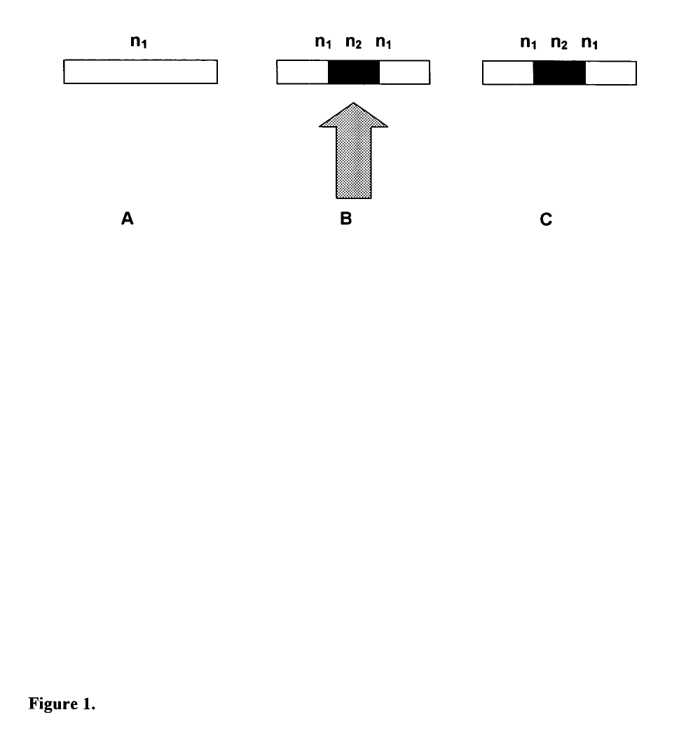

Preferably, the refractive indices n₁ and n₂ of the two materials are designed to match prior to exposure to UV irradiation and which, as a consequence, are completely or substantially transparent. The term “substantially” is used in this application to denote a 5% deviation. Exposure to intense UV irradiation changes exclusively the refractive index of the photoreactive layers, rendering these elements dichroic (FIG. 1C), i.e., transparent for only a well-defined part of the optical spectrum. The refractive index of the photoreactive layer will depend on the extent of the photochemical reaction and correlate with the extent of exposure. Consequently, the optical characteristics of the new multilayer interference films can be controlled by variation of these parameters.

Evidently, standard photolithographic techniques can be employed to allow for spatially resolved patterning.

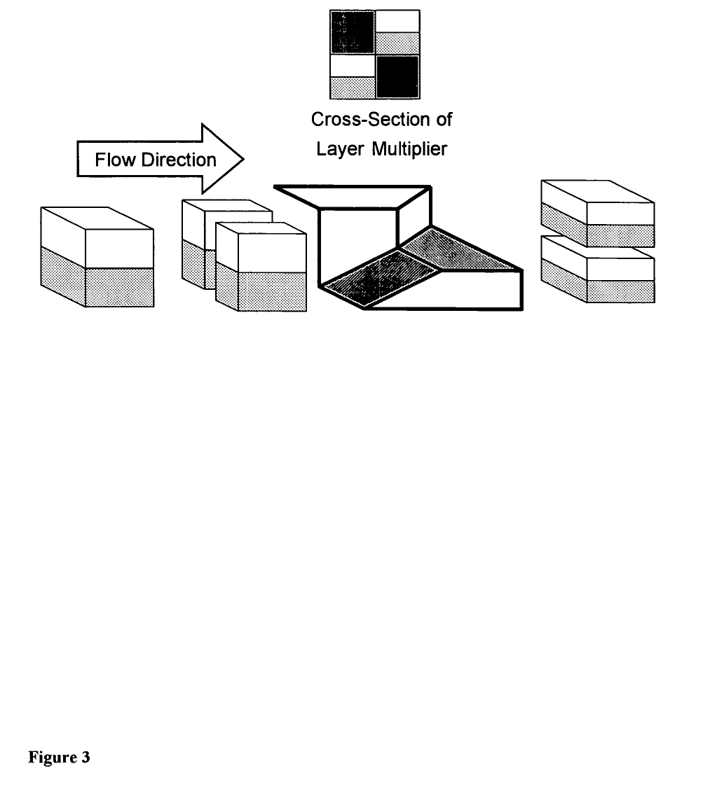

One of the available coextrusion lines allows for processing two-component microlayered films of the envisioned (AB)x formula, where x=2ⁿ, and n is an integer in the range of from 4 to 145, preferably with as many as 4096 layers. The polymer melts are fed into a coextrusion feedblock and then into a series of multiplying elements, up to 11, each of which slices the melt vertically, spreads it horizontally, and recombines it to double the number of layers (FIG. 3). Microlayers can be processed as sheet or film up to 14 inches wide and between 0.1 and 1,000 mils thick, including all increments between this range, preferably between 0.5 to 60 mils thick. By utilizing specially designed multiplier elements and through minimizing the difference of the melt viscosity of the two polymeric materials, good layer homogenity can be provided.

Materials

Interestingly, despite the abundant use of polymeric materials in lithographic processes and notwithstanding the current research activities focused on the subject, few of the available materials promise a successful technological exploitation. Previous work by other groups has been focused on rather sophisticated and expensive materials, for example, tailor-made copolymers featuring a photochromic side chain, and blends of tailor-made photochromic compounds and a transparent host polymer. Another approach has been the, rather uncontrolled decomposition, of conventional optical polymers with high-intensity UV lasers.

Photoreactive polymer systems have been developed in accordance with the present invention, which exclusively rely on commercially available ingredients, and propose to produce blends of an optically transparent polymer and a low-molecular photoreactive compound.

In general, the framework allows the use of well-defined, transparent, commercially available host polymers, such as poly(methyl methacrylate) (PMMA) or polycarbonate (PC), and provides maximum design flexibility with respect to the integration of a photoreactive moiety. The incorporation of a low-molecular photoreactive compound into a host polymer not only makes the resulting blend photoreactive, but (given different refractive indices for the host polymer and the photoreactive compound) also allows to minutely adjust the optical density and refractive index of the blend by variation of the composition. The term “photoreactive compound” or “photoreactive additive” is used herein to indicate a compound with a defined absorption band in the UV regime, and which undergoes a photoreaction upon exposure to UV light. Preferably, the photoreaction is a well controlled reaction.

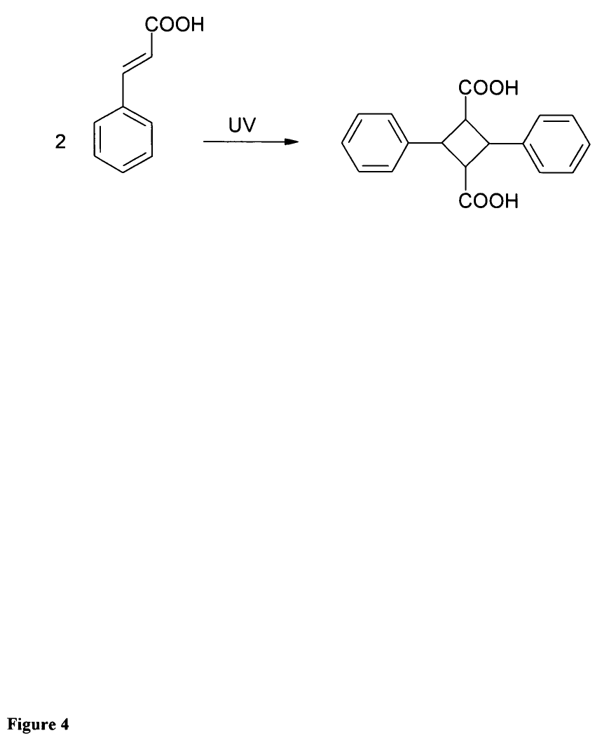

A preferred family of suitable absorbers that we have recently explored in conjunction with a poly(methyl methacrylate) (PMMA) matrix is based on trans-cinnamic acid. This commercially available, inexpensive UV absorber, dimerizes in a 2+2 cycloaddition reaction upon exposure to ultraviolet (UV) light (FIG. 4). A variety of trans-cinnamic acid derivatives is available, which cover a broad range of physico-chemical properties, but exhibit photophysical characteristics that are rather similar. The refractive indices of PMMA (1.489) and trans-cinnamic acid (1.555) and its derivatives are sufficiently different, so that the initial refractive index of homogeneous blends or nanocomposites of these components can be tailored over a rather broad range, simply by adjusting the composition of the material. Because the cycloaddition breaks the conjugation (and therewith the polarizability) of the photoreactive compound, the refractive index of the system is lowered upon exposure to UV light.

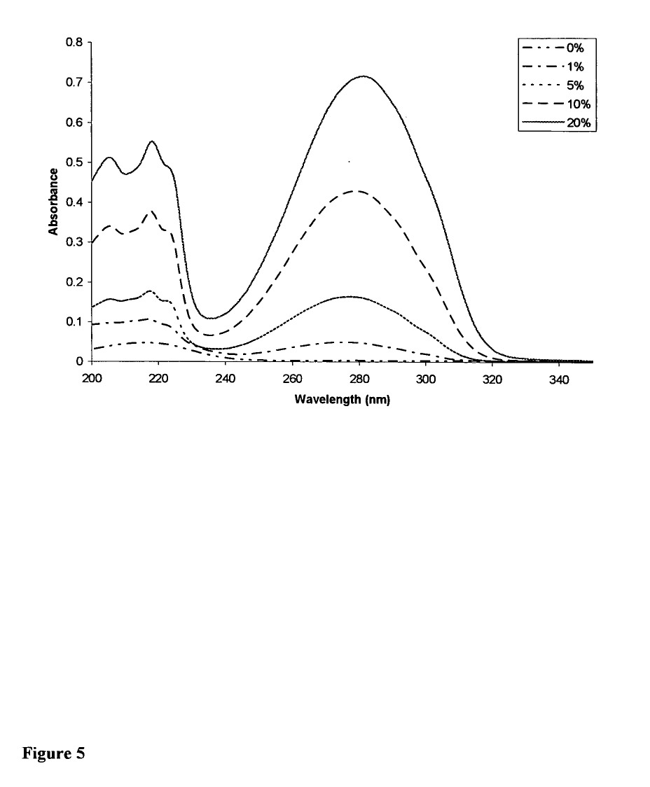

The trans-cinnamic acid features an absorption band around 280 nm, i.e., in a regime that (i) does not overlap with the absorption spectrum of the PMMA (and, thus, the chromophore can selectively be excited), (ii) is compatible with commercially available low-pressure UV-light sources, (iii) leaves the material fully transparent in the entire visible regime. In a set of initial experiments we have prepared blend films of PMMA and cinnamic acid by co-extruding these two components in a co-rotating twin-screw extruder and subsequently melt-pressing the resulting blends into films of a thickness of about 75 μm. Homogeneous blend films were obtained in a concentration range of from 5 to 40 w/w, preferably from 10 to 25% w/w of the photoreactive additive. UV-absorption spectra of films of these blends (which, however, were produced by spin-coating, in order to produce films of an adequate thickness of around 0.5 μm) are shown in FIG. 5.

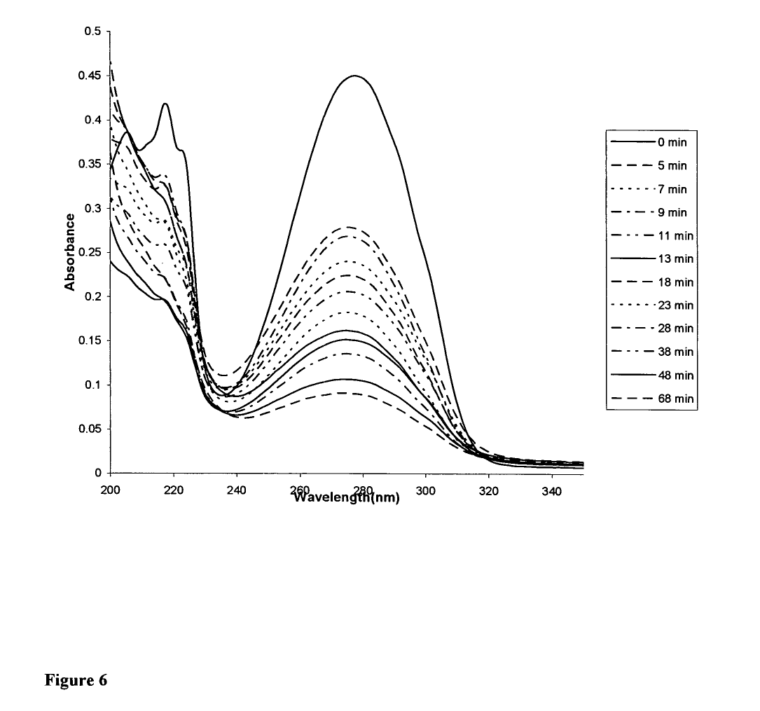

FIG. 6 shows at the example of a blend film based on PMMA and 10% w/w of cinnamic acid that these photoreactive guest molecules readily undergo photodimerization when exposed to UV light. It should be noted that in these initial experiments, the wavelength of the light source employed (254 nm) was not perfectly matched with the absorption maximum of the photoreactive species (280 nm). In addition, it should be pointed out that the energy density of the radiation employed was extremely low, in order to follow the extent of the reaction as a function of time. However, FIG. 4 nicely demonstrates that the extent of cycloaddition—and therewith the refractive index of the exposed material—can carefully be controlled by the exposure time.

Having generally described this invention, a further understanding can be obtained by reference to certain specific examples which are provided herein for purposes of illustration only and are not intended to be limiting unless otherwise specified.

### EXAMPLES

The present invention is directed to light-reflecting multilayer polymer films that irreversibly change their optical characteristics upon exposure to suitable, high-intensity irradiation. Discussed below is the preparation and investigation of photo-reactive polymer blends, which form the basis for the envisioned films. Poly(methyl methacrylate) (PMMA) was chosen as a matrix material, while cinnamic acid (CA) and methyl cinnamate (MC) were employed as the low-molecular weight photoreactive additives. Optical quality films of PMMA/CA and PMMA/MC blends were produced via melt processing and spin coating from solution. The phase behavior of these materials was studied using differential scanning calorimetry (DSC) and dynamic-mechanical thermoanalysis (DMTA) measurements. The data unequivocally demonstrate that all blends are homogeneous molecular mixtures, if the concentration of CA or MC is kept below 25% w/w; at higher concentrations, phase separation does occur. Optical absorption and infrared spectroscopy have confirmed that the CA and MC guest molecules comprised in the investigated blends dimerize as expected in 2+2 cycloaddition reactions. The photoreaction times were of the order of minutes, but the available kinetic data suggest that exposure times in the second or even sub-second regime are feasible when using high-intensity irradiation. Preliminary measurements of refractive indices of PMMA/CA blend films suggest that the addition of CA indeed increases the refractive index. The observed changes are of the order of 0.03 to 0.04 when comparing a 20% w/w PMMA/CA blend with the neat PMMA. Photobleaching of these blends effectively cancels the contribution of the CA guest and restore the refractive index of the matrix material.

Production and Phase Behaviour of PMMA/CA or PMMA/MC Blends

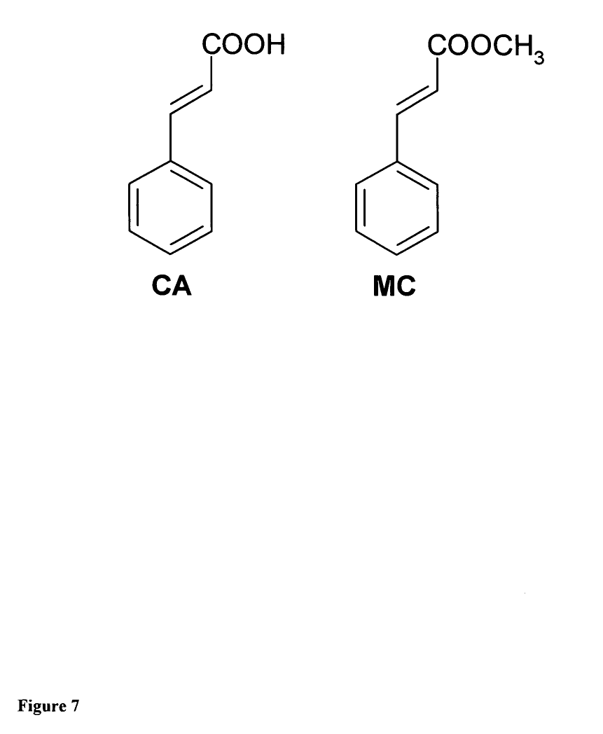

One first family of suitable absorbers that we have elected to use in conjunction with a poly(methyl methacrylate) PMMA matrix is based on trans-cinnamic acid (CA, FIG. 7). Transparent blends films of trans-cinnamic acid and PMMA were prepared by co-extruding these two commercially available components in a co-rotating twin-screw extruder and subsequently melt-pressing the resulting blends into films. In addition, trans-methyl-cinnamate (MC, FIG. 7) has been employed. The photophysical characteristics of MC are essentially identical to those of CA, but the physico-chemical characteristics (polarity, melting temperature, etc.) of these two absorbers are different.

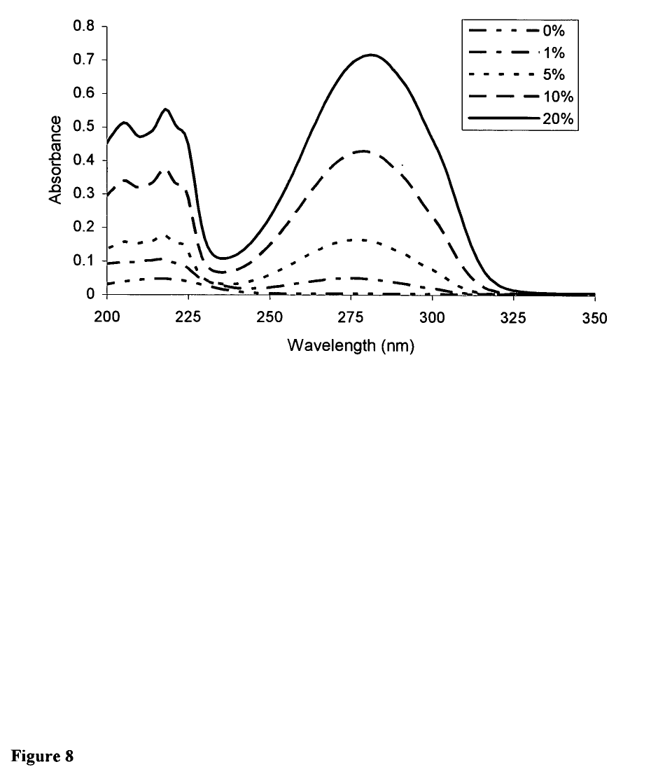

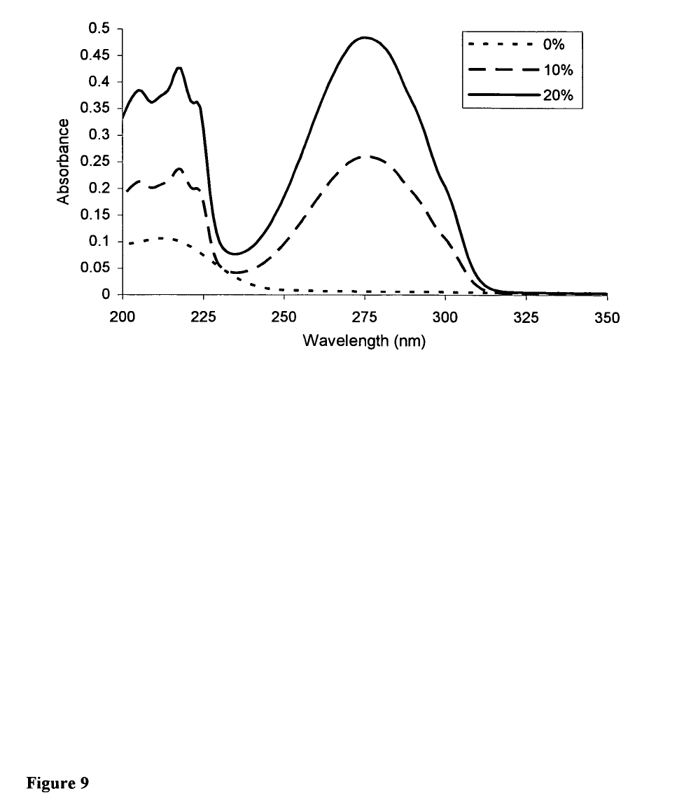

Blend films based on PMMA and up to 25% w/w of the photoreactive additives were produced, varying the concentration of CA or MC in small steps. All materials produced had a homogeneous appearance and were optically clear. UV-absorption spectra of films of these blends (which, however, were produced by spin-coating from solutions, in order to produce films of an adequate thickness of around 0.5 μm) confirm the homogeneous nature of the blends on a macroscopic level (FIGS. 8 and 9). The magnitude of the absorption related to the photoactive guest molecules (around 280 nm) scales directly with its nominal concentration in the blend.

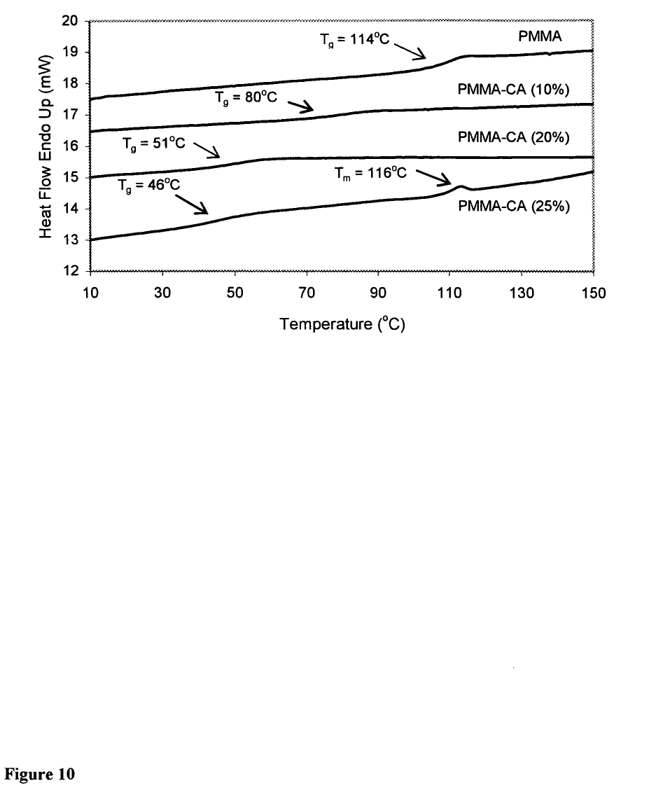

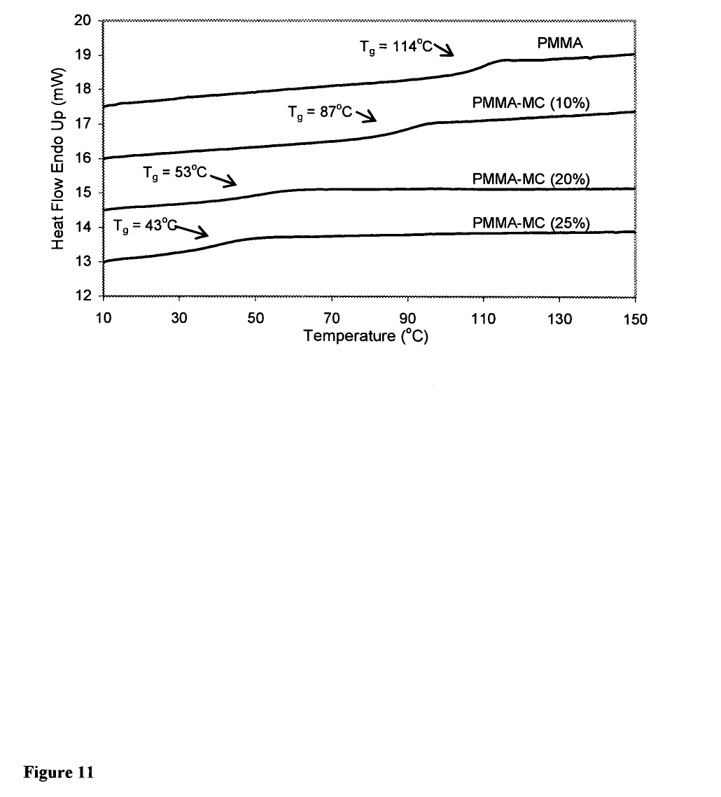

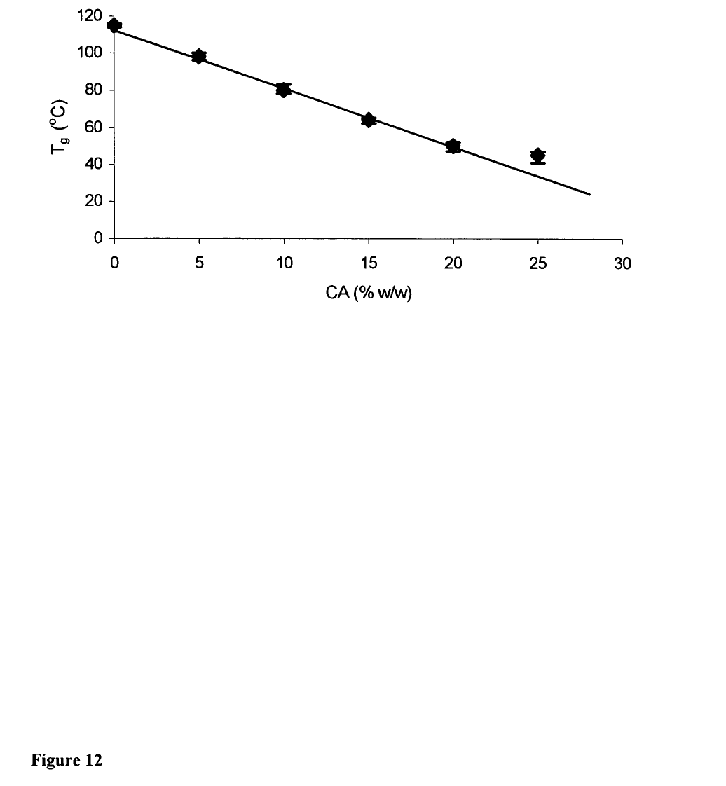

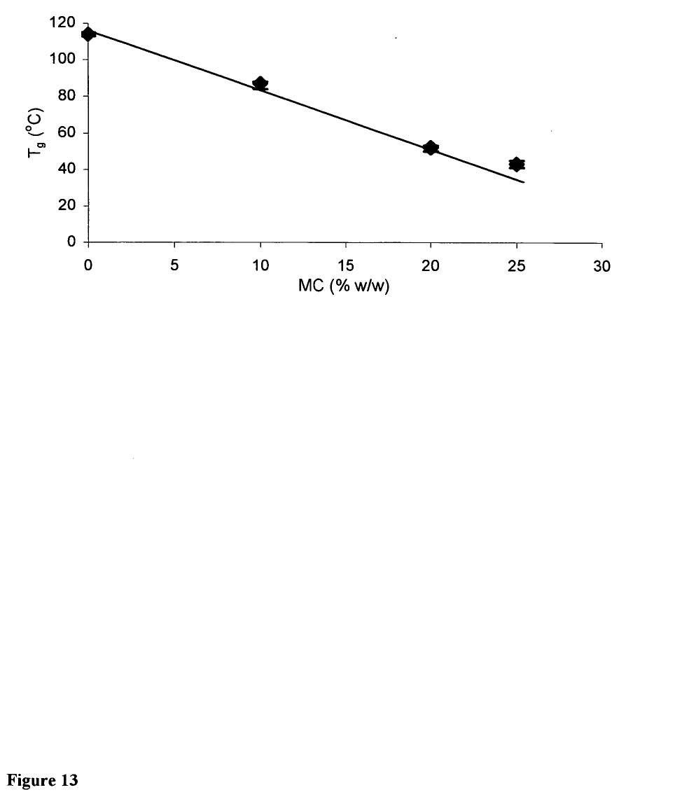

In order to investigate the phase behavior of the PMMA/CA or PMMA/MC blends on a molecular level we have conducted an extensive thermoanalytical study, using differential scanning calorimetry (DSC) and dynamic-mechanical thermoanalysis (DMTA). At guest contents of below 25% w/w, DSC thermograms of the two blend series exclusively show a weak endothermal transition that is associated with the glass transition of the material (FIGS. 10 and 11). The glass transition temperature (T_{g}) of the blends produced inversely scales with the weight fraction of the absorber (FIGS. 12 and 13), indicating that the latter functions as a plasticizer which ‘greases’ the entangled PMMA chains. Thus, these data unequivocally demonstrate that the investigated blends are indeed intimate molecular mixtures. Importantly, in case of the PMMA/CA blend with a guest concentration of 25% w/w, the DSC reveals a weak transition around 116° C. (FIG. 10), which may be associated with the melting of CA crystals and appear to indicate the onset of phase separation (note that the melting temperature of the pure CA is somewhat higher −135° C.; it is therefore assumed that the crystals are small and/or impure). In agreement with this morphology, the T_{g} of this sample also deviates from the linear T_{g}, composition relation that is followed by samples with lower concentration (FIG. 12). A similar behaviour was found for the PMMA/MC blend with a guest concentration of 25% w/w (FIG. 13), although in this case, possibly due to the low melting temperature of MC, no melting transition of the phase-separated guest could be discerned in the DSC trace (FIG. 11). The DSC traces of PMMA blends comprising 20% w/w of either CA or MC remain unchanged upon storing the sample over a period of up to 3 months under ambient conditions, indicating that these homogeneous blends do not phase separate over this period of time.

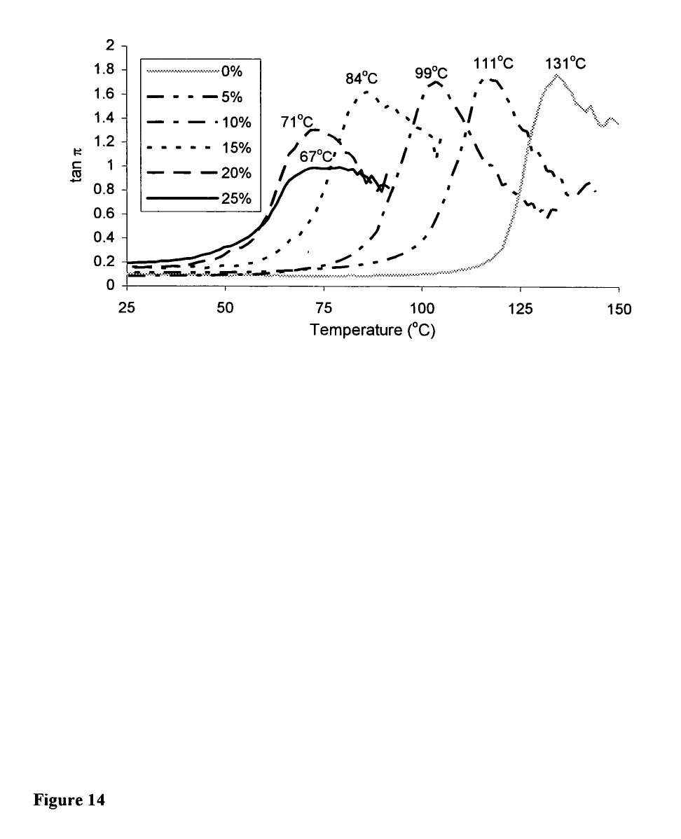

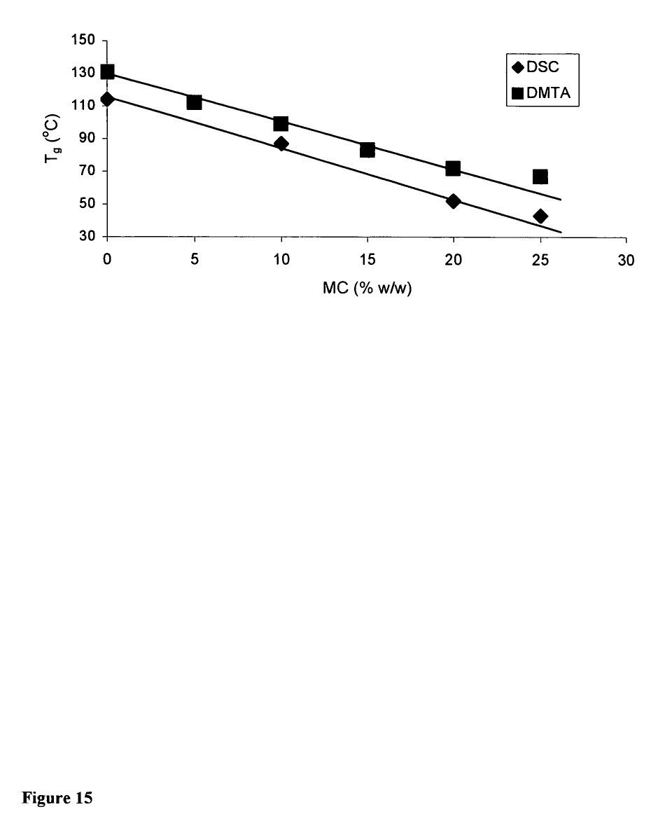

In view of the very low heat flow that is associated with the glass transition of the present systems (cf. FIGS. 10 and 11), we have complemented the DSC study with DMTA experiments. FIG. 14 shows the DMTA traces (tan δ vs. temperature) for a series of PMMA/MC blends. The trend of the glass transition temperatures determined by this method (maximum of the tan δ peak) is in perfect agreement with the DSC data (FIG. 15). Again, it is obvious that the system enters into a non-linear regime at a guest fraction above ca. 20% w/w. The fact that the absolute glass transition temperatures observed by DMTA are about 15 to 20° higher than those determined by DSC is normal and reflects the different dynamics of these two techniques.

In summary, the acquired data unequivocally demonstrate that the investigated PMMA/CA or PMMA/MC blends are homogeneous molecular mixtures, if the concentration of the absorber is kept below 25% w/w; at higher concentrations, phase separation may occur. Thus, with respect to their previously little explored phase behavior, both materials systems are suitable within the scope of the present invention. The similar behavior of PMMA/CA and PMMA/MC blends seems to suggest that the miscibility of the cinnamic acid derivative and PMMA is to a large extent governed by the conjugated core, rather than the nature of the carbonyl group (i.e., acid, ester, aldehyde, etc.). We therefore conclude that also other cinnamic acid derivatives will exhibit the same desirable phase behavior in blends with PMMA.

Photochemical Reaction in PMMA/CA or PMMA/MC Blends

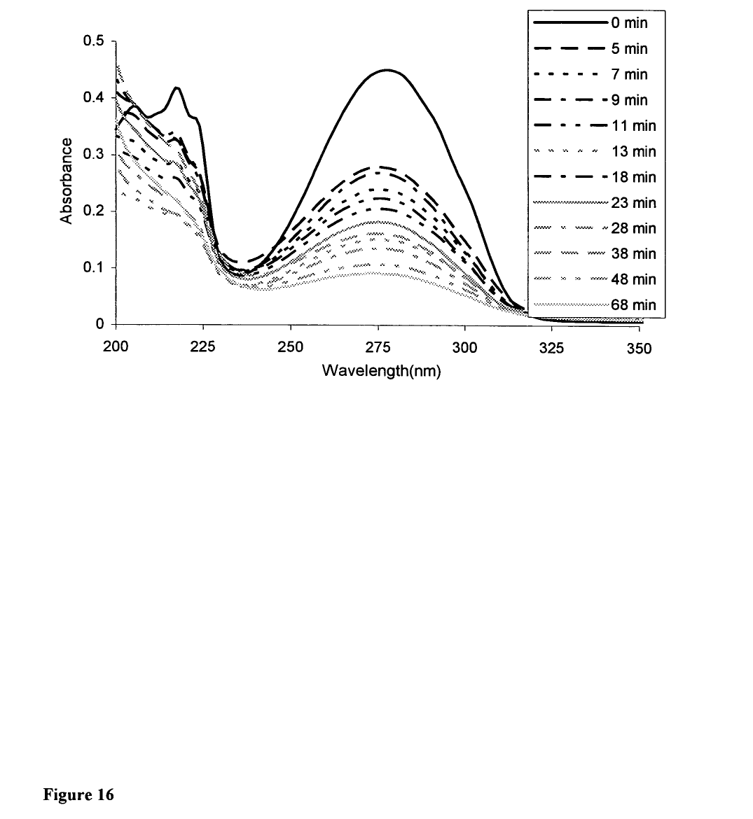

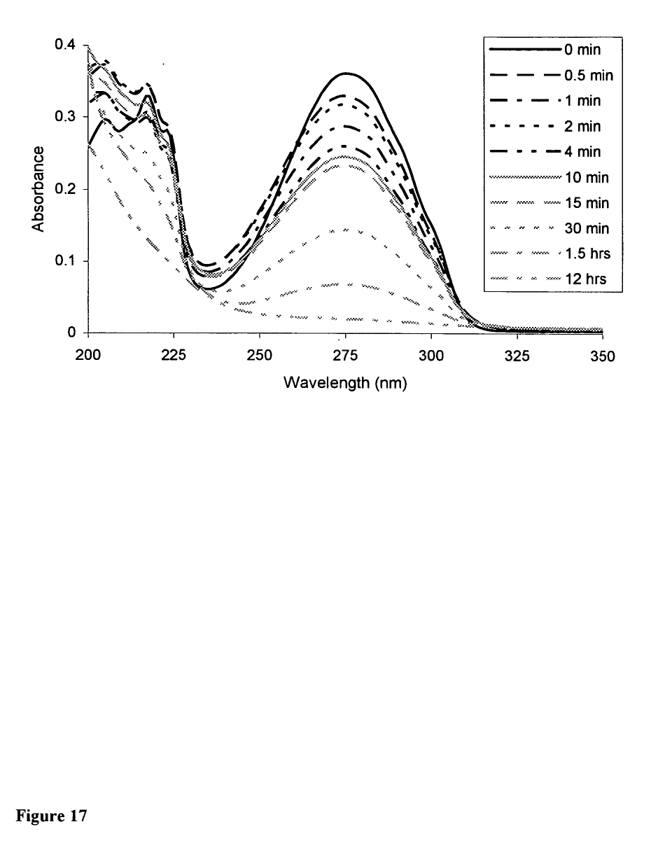

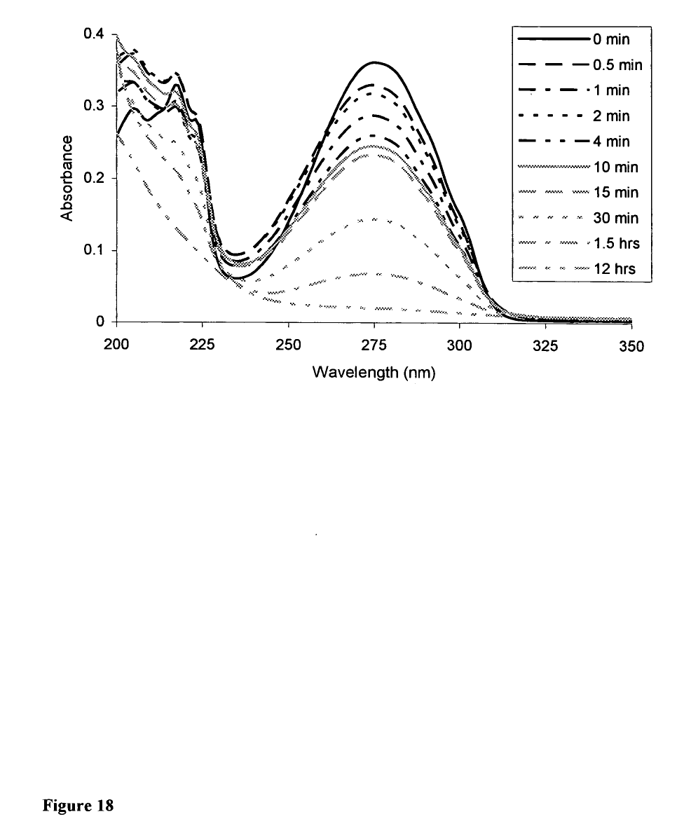

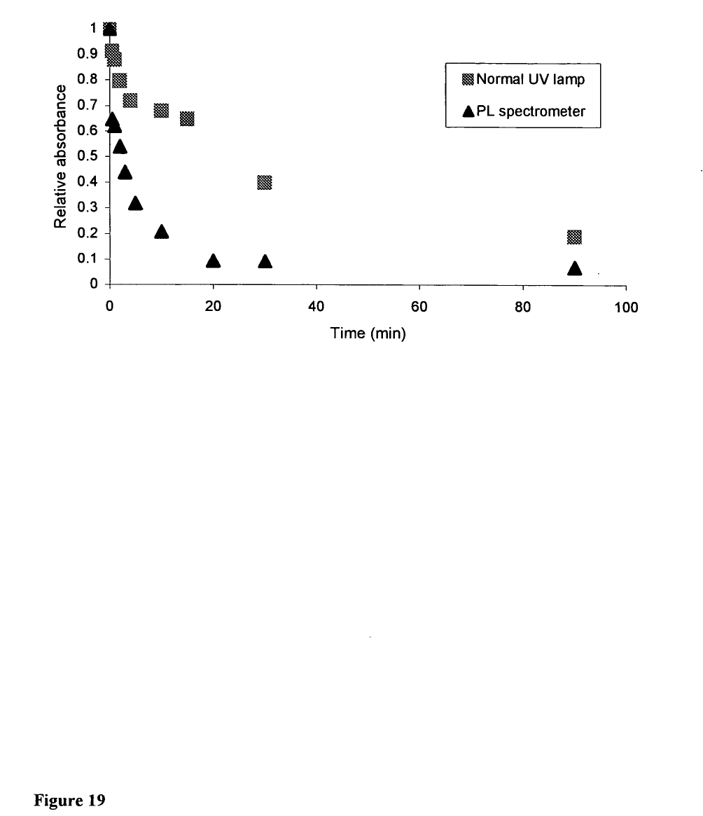

It is well established that trans-cinnamic acid (and derivatives thereof) dimerizes in a 2+2 cycloaddition reaction upon exposure to UV light (FIG. 4). We have shown in an example of a blend film based on PMMA and 10% w/w of cinnamic acid that the optical absorption associated with CA is substantially reduced upon exposure to UV radiation (FIG. 16), indicating that the dimerization also occurs if the CA is incorporated in the PMMA host. We have now also conducted the same experiment with a blend film based on PMMA and 10% w/w of methyl cinnamate (FIG. 17). The behavior of the two materials is essentially the same. In these initial experiments, the wavelength of the light source employed (254 nm) was not well matched with the absorption maximum of the photoreactive species (281 nm in case of CA, 278 nm in case of MC) and the energy density of the radiation employed was extremely low; therefore the photochemical reaction was comparably slow (FIG. 19). We have conducted a comparative experiment, in which the nominal optical energy density was increased by a factor of about four (FIG. 18), using a Xe-lamp with a monochromator that allowed us to match the radiation with the absorption band of the photoreactive compound (absorber). Indeed, as can be seen from FIG. 19, the photochemical reaction proceeded much faster, and a conversion of 50% (based on the reduction of UV absorbance) could be achieved within a few minutes. It is important to point out that light sources with much higher energy densities are available (for example low-cost UV light sources that produce radiation of the order of 10 W/cm² or pulsed Xe-lamps with a power of >10⁴ W/cm²), so that exposure times in the second or even sub-second regime can realistically be envisioned, even for films that are substantially thicker (e.g., 1 mm) than the samples used here (0.5 μm).

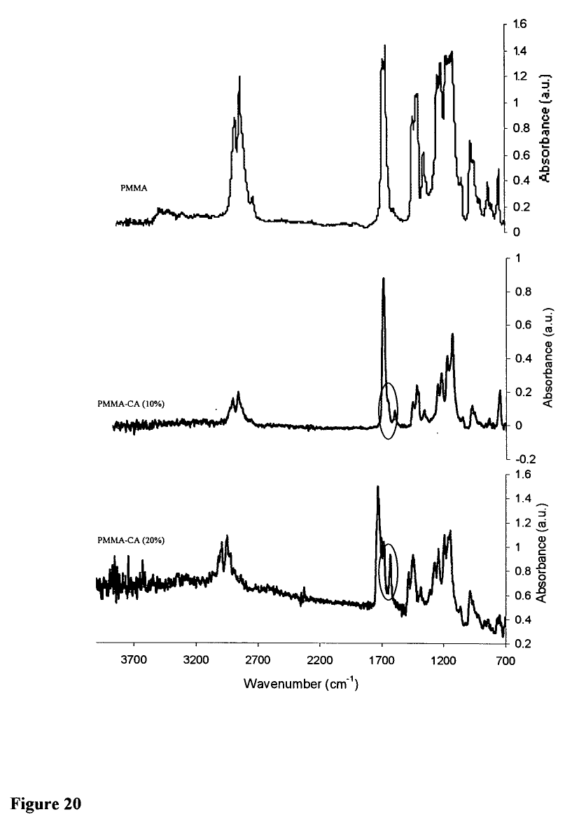

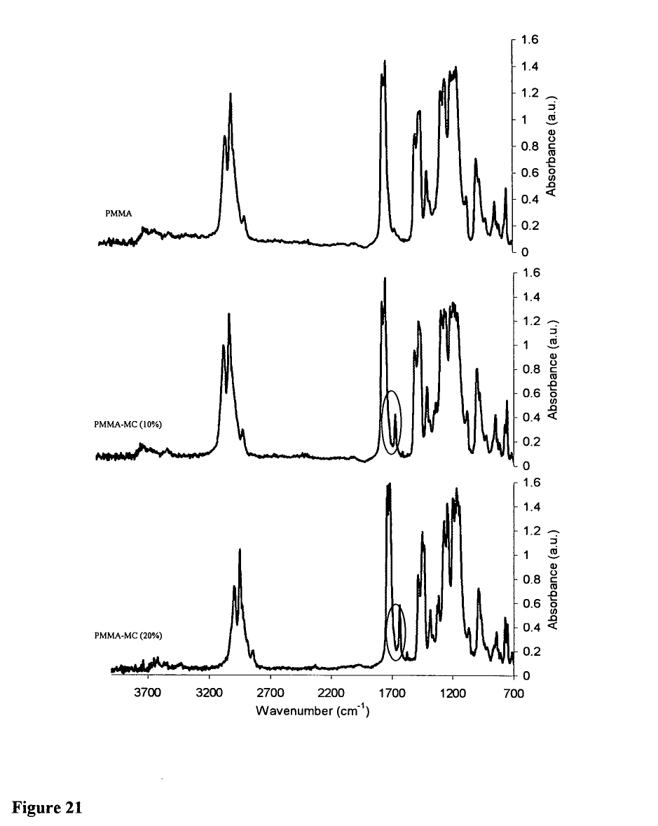

In analogy to a recent study on the photodimerization of trans-cinnamic acid, we have employed infrared (IR) spectroscopy to confirm nature of the photochemical reaction of the PMMA/CA or PMMA/MC blends upon irradiation with UV light. FIGS. 20 and 21 show that the concentration of both CA and MC in the blend can be adequately monitored by the magnitude of a band at 1637 cm⁻¹, which is assigned to the ν(C=C) of the monomeric species. As has been reported for crystals of the pure trans-cinnamic acid, the relative intensity of this band decreases upon irradiating the blend film with UV light, consistent with the consume of the CA or MC and the formation of the saturated dimer depicted in FIG. 4.

In summary the data demonstrate that upon exposure to UV light the guest molecules comprised in the PMMA/CA or PMMA/MC blends dimerize as expected in a 2+2 cycloaddition reaction. In the present study, exposure times of the order of a couple of minutes were required in order to substantially change the chemical composition of the blends. However, these long reaction times are directly related to the low energy of the incident light; since low-cost light sources with much higher energy densities are available, exposure times in the second or even sub-second regime can realistically be envisioned.

Measurements of Refractive Index (RI)

Preliminary measurements of refractive indices of PMMA/CA blend films were carried out on a Metricon prism coupling instrument at Promerus LLC in Brecksville Ohio. Experiments were conducted on free-standing films (thickness ca. 100 μm) that were prepared by melt-processing, as well as on spin-cast films (thickness ca. 1 μm) deposited on various substrates. Samples included PMMA references as well as PMMA/CA blends with CA contents of 10 and 20% w/w. Refractive indices were measured before and after exposure to UV light (12 h, UV lamp 254 nm, 350 μW/cm²). The resulting data are compiled in Tables 1 and 2.

The addition of CA (RI 1.555) indeed appears to increase the RI of the blend in the predicted manner. The observed changes are of the order of 0.03 to 0.04 when comparing a 20% w/w PMMA/CA blend with the neat PMMA. Photobleaching of the blend films prepared by spin-coatings appears to effectively cancel the contribution of the CA guest and restore the refractive index of the neat matrix polymer. Clearly, these substantial changes are sufficiently large for the envisioned applications. It should be noted that the observed change was very pronounced in case of the spin-cast films, while the change was marginal in case of the much thicker free-standing films. As a working hypothesis, it is currently assumed that the optical intensity of the UV radiation employed for the photochemical conversion may have been too low to substantially change the composition of the bulk sample; this assumption is based on the available kinetic data, which were collected on spin-cast films (thickness ca. 0.5-1 μm).

TABLE 1
Refractive indices of PMMA and PMMA/CA blend films (thickness ca.
100 μm) prepared by melt processing. Refractive indices were measured
before and after exposure to UV light (12 h, UV lamp 254 nm,
350 μW/cm²)

| Material | Before Exposure | After Exposure |
|---|---|---|
| PMMA | 1.4966 | 1.497 |
| PMMA-CA (10%) | 1.5225 | 1.5107 |
| PMMA-CA (20%) | 1.5388 | 1.5234 |

TABLE 2
Refractive indices of PMMA and PMMA/CA blend films (thickness ca.
1 μm) prepared by spin-casting. Refractive indices were measured before
and after exposure to UV light (12 h, UV lamp 254 nm, 350 μW/cm²)

| Material | Before exposure | After exposure |
|---|---|---|
| PMMA | 1.4945 | 1.5009 |
| PMMA-CA (10%) | 1.5055 | 1.5054 |
| PMMA-CA (20%) | 1.5214 | 1.5088 |

Alternative Material Systems

As stated above, another preferred material is methyl cinnamate as photoreactive compound. In addition, polycarbonate (PC) is a preferred matrix polymer, preferably in blends with various concentrations of CA.

Refractive Index of PMMA/CA or PMMA/MC Blends

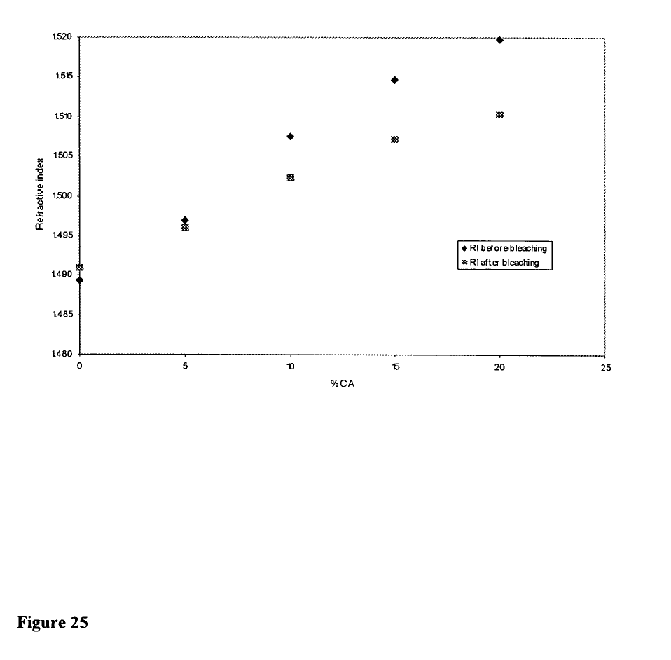

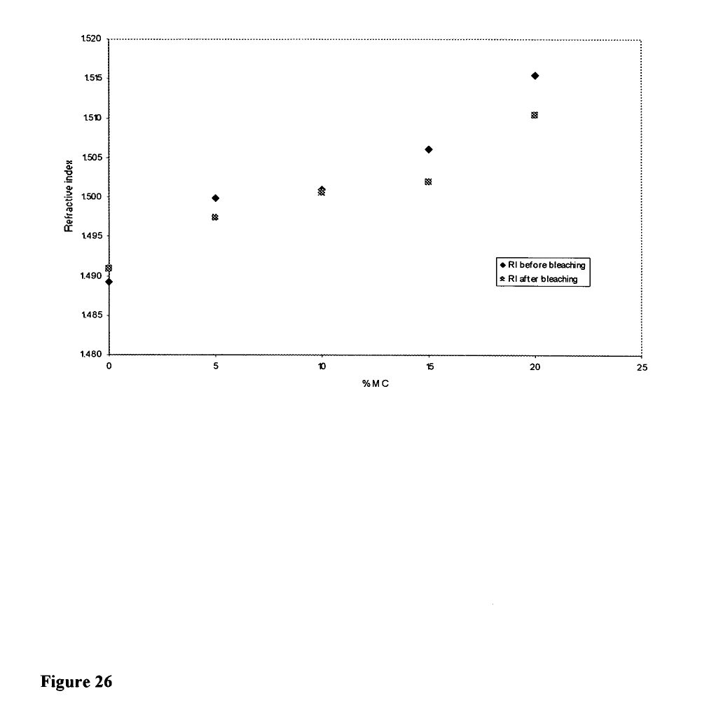

Experiments were conducted on free-standing films (thickness ca. 100 μm) that were prepared by melt-processing. In addition, for the purpose of reference and comparison, we have employed spin-cast films (thickness ca. 1 μm) deposited on various substrates. As can be seen from FIGS. 25 and 26 the changes in RI upon incorporation of CA or MC into the PMMA matrix are substantial. For example the RI increased from 1.4888 to 1.520 when PMMA was blended with 20% w/w CA. The change is somewhat smaller for MC, consistent with the lower polarizability of this molecule; an RI of 1.515 was determined for PMMA blended with 20% w/w MC. Further the RI increases linearly with the concentration of the photoreactive compounds.

The RI of the photoreactive PMMA/CA or PMMA/MC blends decreases as expected (e.g., from 1.520 to 1.5095 for a 20% w/w PMMA/CA blend), if the material is exposed to high doses of high-energy UV-radiation. Refractive indices were measured before and after exposure to UV light (12 h, UV lamp 254 nm, 350 μW/cm²; note that the required exposure time is directly related to the low intensity of the light source employed and the poor spectral overlap between lamp emission and CA/MC absorption). The resulting data are compiled in FIGS. 25 and 26. The data clearly demonstrates that photo-bleaching of the blend films effectively cancels the contribution of the CA and MC guest molecules and reduces the refractive index to a level that is close to the one of the neat matrix polymer. Clearly, these changes are sufficiently large for the envisioned applications. It should be noted that upon photobleaching under the conditions employed, the RI only changed on the surface of the film directed towards the light source, while the optical characteristics of the back-side remained essentially unchanged; this situation is related to the fact that the optical intensity of the UV radiation employed for the photochemical conversion was too low to substantially change the composition of the bulk sample.

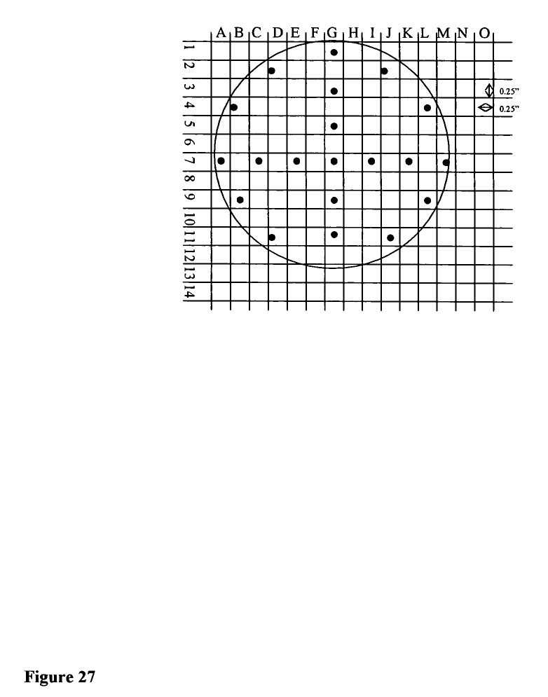

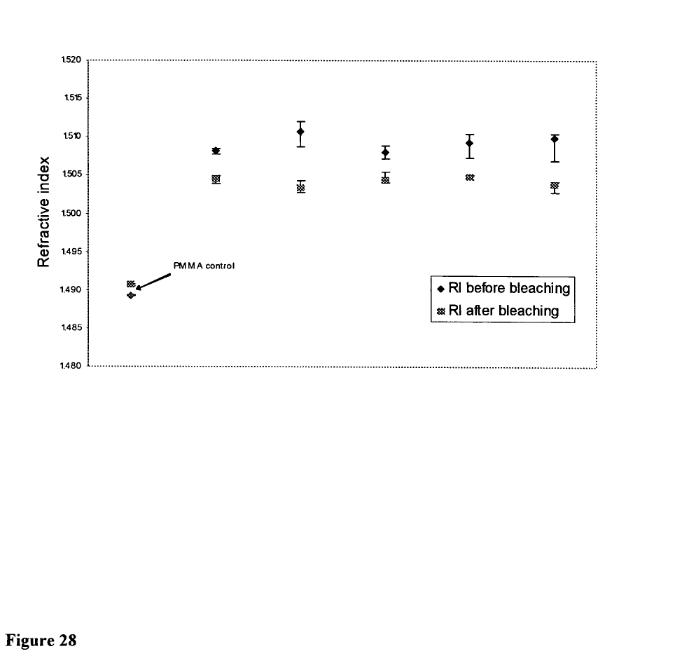

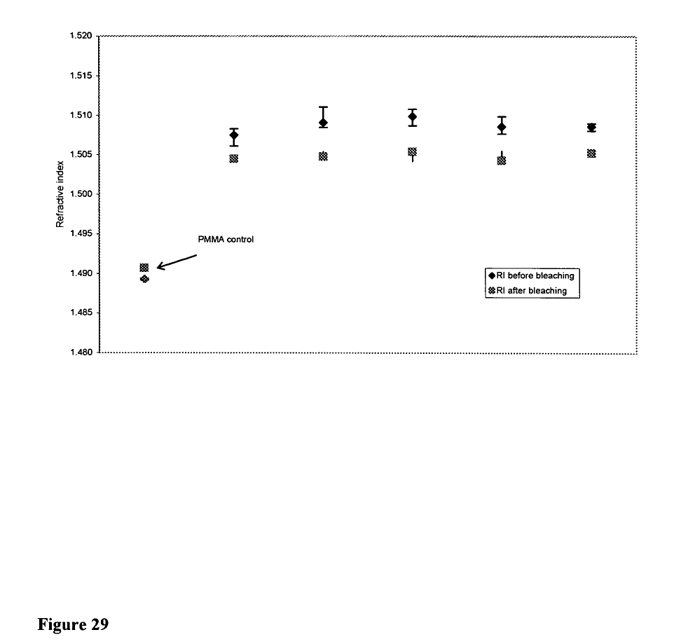

With the fabrication of multilayer films in mind (vide infra), we have scaled-up the blending process used for the production of PMMA/CA or PMMA/MC blends from a 5 g microextruder to a Haake twin-screw extruder, which allows to produce blends on a scale of 1 to 10 pounds. RI measurements of the first generation of blends thus produced were characterized by substantial fluctuations (cf. FIGS. 28 and 29). We systematically investigated the cause of these fluctuations, using a detailed protocol for the determination of refractive indices of the materials at hand. We first established the reliability of the measurement at the example of PMMA reference samples, which were prepared in analogy to the blends. We compared data points from a number of ‘random’ positions on a film sample (employing a grid as shown in FIG. 27 to unequivocally relate a measurement to a position on the sample) using 633 nm as the primary wavelength for these experiments. We frequently employed light of two different polarization states (referred to as TE and TM mode) in order to detect any possible anisotropy in the samples. As can be seen from the data compiled in Table 1, the RI measurements resulted in very uniform values for the RI of the neat PMMA films, confirming the reliability of the methodology on the one hand, and the very good homogeneity of these reference samples on the other.

TABLE 3
Refractive index measurement on a film of PMMA (grade V920). Points
refer to the position on a grid as shown in FIG. 27.
Wavelength = 633 nm.

| Vertical diameter | | | | | Horizontal diameter | | | | | Circumference (clockwise) | | | | |
|---|---|---|---|---|---|---|---|---|---|---|---|---|---|---|
| | Initial | | 2 days later | | | Initial | | 2 days later | | | Initial | | 2 days later | |
| Point | TE | TM | TE | TM | Point | TE | TM | TE | TM | Point | TE | TM | TE | TM |
| G1 | 1.4893 | 1.4893 | 1.4893 | 1.4893 | A7 | 1.4893 | 1.4893 | 1.4893 | 1.4893 | J2 | 1.4892 | 1.4892 | 1.4892 | 1.4892 |
| G3 | 1.4892 | 1.4893 | 1.4893 | 1.4893 | C7 | 1.4892 | 1.4892 | 1.4892 | 1.4892 | L4 | 1.4892 | 1.4893 | 1.4893 | 1.4893 |
| G5 | 1.4894 | 1.4894 | 1.4893 | 1.4894 | E7 | 1.4891 | 1.4892 | 1.4892 | 1.4892 | L10 | 1.4892 | 1.4892 | 1.4892 | 1.4892 |
| G7 | 1.4891 | 1.4891 | 1.4892 | 1.4892 | G7 | 1.4892 | 1.4892 | 1.4893 | 1.4892 | J12 | 1.4888 | 1.4890 | 1.4890 | 1.4890 |
| G9 | 1.4892 | 1.4893 | 1.4893 | 1.4893 | I7 | 1.4891 | 1.4891 | 1.4890 | 1.4891 | D12 | 1.4891 | 1.4891 | 1.4892 | 1.4891 |
| G11 | 1.4891 | 1.4892 | 1.4893 | 1.4892 | K7 | 1.4891 | 1.4892 | 1.4891 | 1.4892 | B10 | 1.4892 | 1.4892 | 1.4892 | 1.4892 |
| | | | | | M7 | 1.4891 | 1.4891 | 1.4891 | 1.4891 | B4 | 1.4891 | 1.4891 | 1.4892 | 1.4891 |
| | | | | | | | | | | D2 | 1.4890 | 1.4890 | 1.4890 | 1.4891 |

As can be seen from FIGS. 28 and 29, the uniformity of the refractive indices determined for blend films prepared from initial PMMA/CA and PMMA/MC blends (produced on a pound-scale on a Haake twin-screw extruder) was substantially lower. As evidenced by the data exemplarily compiled for one PMMA/CA film sample in Table 2, the RI of these samples shows a strong positional dependence, consistent with a substantial inhomogeneity of the blends due to improper mixing. As demonstrated by the data shown in Table 3, the homogeneity of the blends could be dramatically improved by remixing the blend (under addition of another portion of CA) by three consecutive mixing cycles using the Haake twin-screw extruder.

TABLE 4
Refractive indices at different points of a compression-
molded film of PMMA-CA blend comprising 11.1% w/w
of CA made by blending in a Haake twin-screw
extruder. Average RI = 1.5091 ± 0.0035

| Vertical diameter | | | | Horizontal diameter | | | | Circumference (clockwise) | | | |
|---|---|---|---|---|---|---|---|---|---|---|---|
| | | 2 days later | | | | 2 days later | | | | 2 days later | |
| Point | Initial | TE | TM | Point | Initial | TE | TM | Point | Initial | TE | TM |
| G1 | 1.5110 | | | A6 | 1.5136 | | | I2 | 1.5109 | 1.5108 | 1.5109 |
| G2 | 1.5126 | 1.5129 | 1.5129 | B6 | 1.5130 | 1.5064 | 1.5065 | K4 | 1.5079 | 1.5080 | 1.5079 |
| G3 | 1.5133 | | | C6 | 1.5110 | | | K8 | 1.5059 | 1.5061 | 1.5060 |
| G4 | 1.5128 | | | D6 | 1.5088 | | | I11 | 1.5060 | 1.5060 | 1.5060 |
| G5 | 1.5106 | | | E6 | 1.5082 | 1.5083 | 1.5083 | E11 | 1.5058 | 1.5059 | 1.5059 |
| G6 | 1.5090 | 1.5092 | 1.5093 | F6 | 1.5079 | | | B8 | 1.5126 | 1.5128 | 1.5128 |
| G7 | 1.5109 | | | G6 | 1.5090 | 1.5092 | 1.5093 | B4 | 1.5112 | 1.5112 | 1.5112 |
| G8 | 1.5048 | | | H6 | 1.5073 | | | D2 | 1.5082 | 1.5083 | 1.5084 |
| G9 | 1.5059 | | | I6 | 1.5086 | 1.5084 | 1.5084 | | | | |
| G10 | 1.5065 | 1.5067 | 1.5067 | J6 | 1.5061 | | | | | | |
| | | | | K6 | 1.5064 | | | | | | |
| | | | | L6 | 1.5068 | 1.5070 | 1.5070 | | | | |

TABLE 5
Refractive index distribution of a film of the above
PMMA-CA blend, after increasing the CA concentration
to 14.3% and remixing 3 × in the Haake twin-screw
extruder. Average RI = 1.5148 ± 0.0004

| Vertical | | | Horizontal | | | Circumference | | |
|---|---|---|---|---|---|---|---|---|
| diameter | | | diameter | | | (Clockwise) | | |
| Point | TE | TM | Point | TE | TM | Point | TE | TM |
| G1 | 1.5152 | 1.5154 | C6 | 1.5153 | 1.5153 | J2 | 1.5151 | 1.5152 |
| G3 | 1.5151 | 1.5151 | E6 | 1.5149 | 1.5148 | K4 | 1.5156 | 1.5155 |
| G6 | 1.5147 | 1.5147 | G6 | 1.5141 | 1.5141 | K8 | 1.5152 | 1.5152 |
| G8 | 1.5148 | 1.5148 | I6 | 1.5150 | 1.5149 | J10 | 1.5150 | 1.5151 |
| G10 | 1.5151 | 1.5151 | K6 | 1.5154 | 1.5153 | E10 | 1.5154 | 1.5152 |
| | | | | | | C8 | 1.5151 | 1.5151 |
| | | | | | | C4 | 1.5151 | 1.5151 |
| | | | | | | E2 | 1.5151 | 1.5151 |

Multilayer Films of PMMA/BzPO Blends

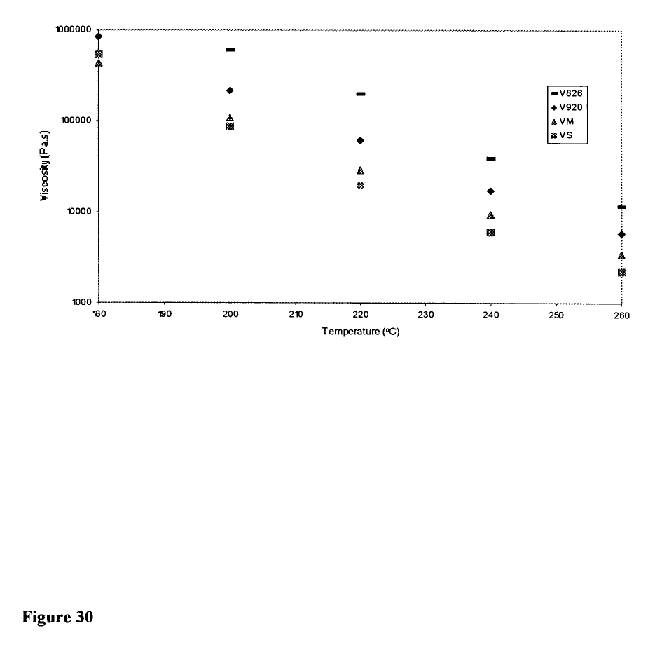

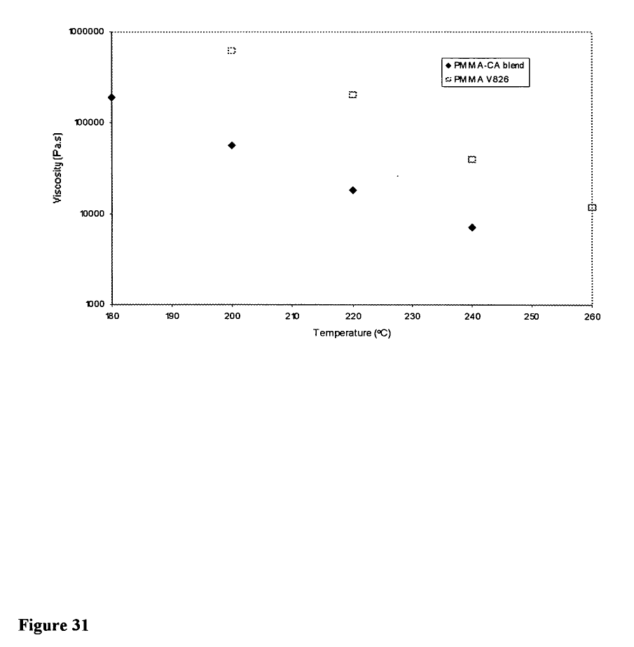

Applicants have established the melt-rheology of PMMA/CA blends of preferred concentration, along with the rheology of preferred polymers. FIG. 30 shows the viscosity-temperature curves of four different commercial grades of PMMA. The melt viscosity was determined from melt flow indexing (MFI) experiments, by measuring the amount of polymer flowing under a specific load in a specific time at each temperature. Due to its high melt-viscosity, the PMMA grade V826 was selected for blending with CA. As can be seen from FIG. 31, the decoration of PMMA with the photoreactive guest molecules reduces the melt-viscosity of the system dramatically. One important requirement for the success of the multilayering process is, however, a matching rheological behavior of the two materials employed. We have therefore elected to employ for the ‘passive’ layer PMMA grades that are characterized by a lower molecular weight and hence reduced viscosity than V826. As is apparent when comparing the data shown in FIGS. 30 and 31, the viscosity of the PMMA/CA blends is matched rather well with PMMA grades VM and VS, if the concentration of CA in the blend is around 15% w/w. It should be noted that the refractive indices of the four neat PMMA grades employed are essentially identical (PMMA V826: 1.4898±0.0002; PMMA V920: 1.4892±0.0001; PMMA VM: 1.4885±0.0002; PMMA VS: 1.4888±0.0002).

Based on the above Theological data, we have produced a VS-PMMA/CA blend comprising 12% w/w of CA. by premixing PMMA with a paste of cinnamic acid in acetone, and extruding the mixture twice on a Haake twin screw extruder. As shown in Table 4, this material displayed a very good optical uniformity, with an average refractive index of 1.5106±0.0004.

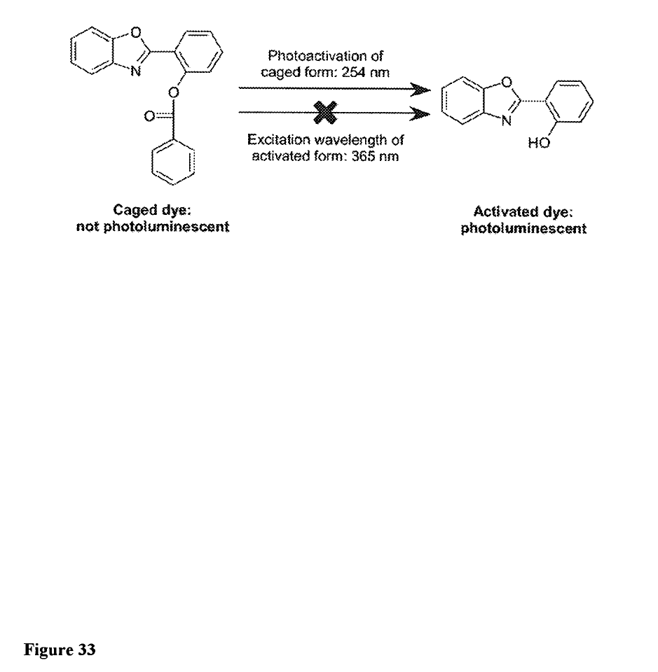

We have prepared a number of multilayer films based on the above V826-PMMA/CA blend and PMMA-VS and polycarbonate (PC) as the alternate layer. In both systems, the composition chosen was 50/50, and the number of layers was kept at 1024. Multilayer films of a thickness of 2 mils, 4 mils and 8 mils were co-extruded, which led to a layer thickness of 50, 100 and 200 nm, respectively. To the best of our knowledge, these multilayer films represent the first embodiment of melt-extruded multilayer structures that comprise a reactive layer. The optical appearance of these photoreactive multilayer films can be changed through exposure to UV-light. As shown in FIG. 33, an initially semi-transparent multilayer film based on PMMA and PMMA/CA is readily bestowed with a clearly distinguishable pattern, if exposed (in this case through a chessboard-type mask) to high-intensity UV light.

TABLE 6
Refractive index distribution of a film of the PMMA-CA
blend being used for microlayering. The blend comprised
12% w/w of CA and was produced by premixing PMMA
with a paste of cinnamic acid in acetone, and extruding
the mixture twice on a Haake twin-screw extruder at
190° C. Average RI of film = 1.5106 ± 0.0004

| Vertical | | | Horizontal | | | Circumference | | |
|---|---|---|---|---|---|---|---|---|
| diameter | | | diameter | | | (clockwise) | | |
| Point | TE | TM | Point | TE | TM | Point | TE | TM |
| G1 | 1.5107 | 1.5106 | B6 | 1.5109 | 1.5108 | I2 | 1.5110 | 1.5110 |
| G4 | 1.5110 | 1.5110 | E6 | 1.5102 | 1.5102 | K4 | 1.5108 | 1.5108 |
| G6 | 1.5106 | 1.5106 | G6 | 1.5102 | 1.5102 | K8 | 1.5109 | 1.5108 |
| G8 | 1.5101 | 1.5101 | I6 | 1.5101 | 1.5101 | I10 | 1.5109 | 1.5110 |
| G10 | 1.5101 | 1.5102 | K6 | 1.5107 | 1.5108 | D10 | 1.5110 | 1.5110 |
| | | | | | | C8 | 1.5109 | 1.5109 |
| | | | | | | C4 | 1.5105 | 1.5105 |
| | | | | | | E2 | 1.5109 | 1.5108 |

Multilayer Films of PMMA/CA Blends

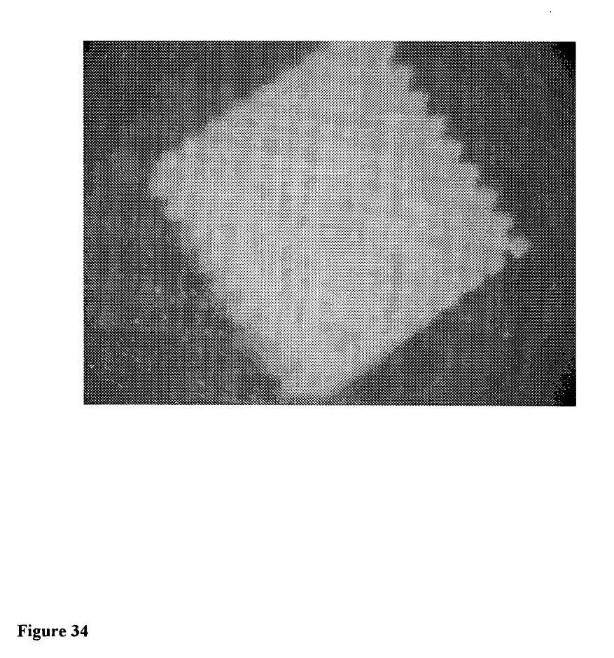

We have expanded our activities to materials systems that comprise photoluminescent photoreactive guest molecules. We have recently discovered that the esterification of the photoluminescent 2-(2′-hydroxyphenyl)benzoxazole (HPBO) with aromatic acids leads to a novel family of ‘caged’ photoluminescent dyes (FIG. 33). The latter are no longer photoluminescent, but upon exposure to appropriate UV radiation, the ester bond is cleaved and the photoluminescent HPBO is quantitatively restored. This photoactivation process follows first-order reaction kinetics, with quantum yields between 7 and 38%, depending on the nature of the photocleavable ester group. The esterification of HPBO induces a significant hypsochromic shift to the absorption spectrum of the chromophore, creating a wavelength regime in which the activated HPBO can be excited, while the HPBO-ester remains caged. Thus, the caged/uncaged dye pairs can be developed and detected with high selectivity (i.e., using UV light at 254 and 365 nm, respectively). HPBO esters further offer the advantage of high thermal stability, which renders them useful for application in melt-processed polymer blends. This possibility can be exploited in the production of photoluminescent images in polymer films, and the visualization of flow patterns in a polymer melt. We have now produced a blend of PMMA (grade V826) and 0.2% w/w BzPO, by blending at 270° C. in the Haake twin-screw extruder. This material formed the basis for a multilayer film, employing PC as the second polymer. Multilayer films comprising 1024 layers of a thickness of 75 nm exhibit the typical ‘metallic’ sheen associated with the reflecting characteristic of this architecture. Upon photoactivation (exposure to UV light of a wavelength of 254 nm), BzPO is immediately converted to the highly luminescent parent HPBO. As can be seen from FIG. 34, this process allows to readily write a ‘pattern’ into the reflective multilayer film, if an adequate mask is applied.

Obviously, numerous modifications and variations of the present invention are possible in light of the above teachings. It is therefore to be understood that within the scope of the appended claims, the invention may be practiced otherwise than as specifically described herein.

1. A multilayer structure comprising,
a plurality of at least two alternating layers A and B represented by formula (AB)ₓ, where x=2ⁿ, and n is in the range of from 4 to 15; and
wherein layer A is comprised of components (a) and layer (B) is comprised of component (b); and wherein component (a) comprises a matrix polymer and component (b) comprises a matrix polymer and a photoreactive compound dispersed therein.

2. The multilayer structure of claim 1, wherein the refractive indexes of layers A and B are substantially the same and the multilayer structure is substantially transparent.

3. The multilayer structure of claim 1, wherein the refractive index of the photoreactive compound is changed upon exposure to UV light.

4. The multilayer structure of claim 1, wherein upon exposure to UV irradiation layers A and B are rendered dichroic.

5. The multilayer structure of claim 1, wherein said structure is a film or a sheet.

6. The multilayer structure of claim 5, wherein the thickness of said film or sheet is in the order of between 0.1 to 1,000 mils.

7. The multilayer structure of claim 5, wherein the thickness of said film or sheet is in the order of between 0.5 to 60 mils.

8. The multilayer structure of claim 1, wherein said matrix polymer is poly(methyl methacrylate) and the photoreactive compound is selected from the group consisting of a trans-cinnamic acid derivative and BzPO.

9. The multilayer structure of claim 8, wherein said cinnamic acid derivative is selected from the group consisting of trans-cinnamic acid and methyl cinnamate.

10. The multilayer structure of claim 1, wherein said photoreactive compound is present in an amount of from 5 to 40% w/w.

11. The multilayer structure of claim 1, wherein said photoreactive compound is present in an amount of from 10 to 25% w/w.

12. The multilayer structure of claim 5, wherein photobleaching cancels the contribution of the photoreactive compound and restores the refractive index of the neat matrix polymer.

13. A method for forming the multilayer structure of claim 1, comprising
extruding component (a) in an extruder (A) to form a melt stream (A) and component (b) in an extruder (B) to form a melt stream (B);
combining melt stream (A) with melt stream (B) in a feed block to form parallel layers (A) and (B);
advancing said parallel layers through a series of multiplying elements (n) to form the multilayer structure.
